(19) United States
(12) Patent Application Publication
(10) Pub. No.: US 2024/0025301 A1
(43) Pub. Date: Jan. 25, 2024

(54) METHOD AND SYSTEM FOR PROVIDING INFORMATION FOR DETERMINING WHETHER TO ENTER BATTERY PRE-CONDITIONING

(71) Applicants: HYUNDAI MOTOR COMPANY, Seoul (KR); KIA CORPORATION, Seoul (KR)

(72) Inventor: Hyun Soo Park, Seoul (KR)

(73) Assignees: HYUNDAI MOTOR COMPANY, Seoul (KR); KIA CORPORATION, Seoul (KR)

(21) Appl. No.: 18/076,988

(22) Filed: Dec. 7, 2022

(30) Foreign Application Priority Data
Jul. 19, 2022 (KR) 10-2022-0089095

(51) Int. Cl. B60L 58/24; B60L 58/12; H01M 10/48; H01M 10/615; H01M 10/625; H01M 10/63; H01M 10/44

(52) U.S. Cl. CPC B60L 58/24; B60L 58/12; H01M 10/486; H01M 10/615; H01M 10/625; H01M 10/63; H01M 10/446; B60L 2240/545; B60L 53/62

(57) ABSTRACT

A method and system for providing information for determining whether to enter battery pre-conditioning includes: searching for at least one charging station that satisfies a certain condition based on a current location of a vehicle; determining charging condition information about at least one found charging station for each case of performing battery pre-conditioning and not performing battery pre-conditioning; and outputting the determined charging condition information.

### CROSS REFERENCE TO RELATED APPLICATION

The present application claims priority to Korean Patent Application No. 10-2022-0089095, filed on Jul. 19, 2022, the entire contents of which are incorporated herein for all purposes by this reference.

### TECHNICAL FIELD

The present disclosure relates to a method and system for providing information for determining whether to enter battery pre-conditioning, in which charging conditions, varied depending on the battery pre-conditioning, are determined according to charging stations. Further, the present disclosure relates to a method and system for determining whether to enter the battery pre-conditioning based on information about the determined charging conditions.

### BACKGROUND

An electrified vehicle refers to a vehicle that employs an electric motor as a driving source. In particular, an electrified vehicle includes a plug-in hybrid electric vehicle (PHEV) or electric vehicle (EV) of which a battery is chargeable with external power through connection of a charging plug.

When a battery of an electrified vehicle is charged, the charging time of the battery may be significantly affected by the temperature of the battery. Thus, the temperature of the battery is appropriately raised in advance by a method or the like of circulating a fluid (e.g., water) heated by an electric heater around the battery, thereby shortening the charging time. Such control of raising the temperature of the battery ahead of time is called “battery conditioning” or “battery pre-conditioning.”

In the related arts to battery pre-conditioning, it is generally determined only whether the temperature of the battery is at an optimum temperature for charging or not, and the battery pre-conditioning is performed when the temperature of the battery is not the optimum temperature.

However, battery pre-conditioning consumes additional energy as compared with that consumed in a simple trip to a charging station because additional energy is consumed in raising the temperature of the battery. Further, the charging time and charging cost increase to charge the battery for what was discharged by the additionally consumed energy. Therefore, the effect of shortening the charging time based on the temperature raised by the battery pre-conditioning may be offset by the energy consumption caused by the battery pre-conditioning. In addition, when the battery pre-conditioning is performed based on a time of arrival at a charging station, the arrival time may not match the charging start time due to a waiting time after the arrival, and the like. In this case, control is additionally required to maintain the optimum charging temperature until actual charging is started, and thus the energy consumption is also increased.

The battery generates heat as the energy stored in the battery is used for traveling. Therefore, the temperature of the battery rises even when the battery pre-conditioning is not performed.

Taking such points into account, it is necessary to determine whether to enter battery pre-conditioning based on a combination of energy consumption due to the battery pre-conditioning, temperature rise of the battery due to travel, and the like.

Matters described as the related art are provided merely to promote understanding of the background of the disclosure. Accordingly, these matters should not be taken as the prior art already known to a person having ordinary skill in the art.

### SUMMARY

An aspect of the disclosure is to provide a method and system for providing information for determining whether to enter battery pre-conditioning. Information about the charging of an electrified vehicle is provided according to cases with and without battery pre-conditioning, thereby effectively determining whether to enter the battery pre-conditioning.

Technical problems to be solved in the disclosure are not limited to the aforementioned technical problems. Additionally, other unmentioned technical problems can be clearly understood from the following description by a person having ordinary skill in the art to which the disclosure pertains.

According to an embodiment of the disclosure, a method of providing information for determining whether to enter battery pre-conditioning includes: searching for at least one charging station that satisfies a certain condition based on a current location of a vehicle; determining charging condition information about at least one found charging station for each case of performing battery pre-conditioning and not performing battery pre-conditioning; and outputting the determined charging condition information.

For example, the charging condition information may include at least one of an expected charging cost or an expected charging time.

For example, the charging condition information may further include an expected state of charge (SOC) upon a time of arrival at the found charging station. In addition, the determining the charging condition information may include: determining the expected SOC for each case of performing battery pre-conditioning and not performing battery pre-conditioning; and determining the expected charging time or the expected charging cost for each case of performing battery pre-conditioning and not performing battery pre-conditioning, based on the determined expected SOC.

For example, the determining the expected SOC may include determining the expected SOC based on a current SOC, travel energy consumption due to travel to the found charging station, and conditioning consumption energy due to the battery pre-conditioning.

For example, the charging condition information may include an expected battery temperature upon a time of arrival at the found charging station. In addition, the determining the charging condition information may include: determining an expected battery temperature for each case of performing battery pre-conditioning and not performing battery pre-conditioning; and determining an expected charging time for each case of performing battery pre-conditioning and not performing battery pre-conditioning, based on the determined expected battery temperature.

For example, the determining the expected battery temperature may include determining the expected battery temperature based on a current temperature of the battery, a temperature raised by travel to the found charging station, and a temperature raised by the battery pre-conditioning.

For example, the method may further include checking charging station information including output specifications of a charger at each found charging station. In addition, the determining the charging condition information may include determining the charging condition information by additionally considering the charging station information.

For example, the method may further include receiving an input of a command for whether to perform the battery pre-conditioning after the outputting.

According to an embodiment of the disclosure, a system for providing information for determining whether to enter battery pre-conditioning includes: a searching unit configured to search for at least one charging station that satisfies a certain condition based on a current location of a vehicle; a determining unit configured to determine charging condition information about at least one found charging station for each case of performing battery pre-conditioning and not performing battery pre-conditioning; and an interface unit configured to output the determined charging condition information.

For example, the charging condition information may include at least one of an expected charging cost or an expected charging time.

For example, the charging condition information may further include an expected state of charge (SOC) upon a time of arrival at the found charging station. In addition, the determining unit may be configured to determine the expected SOC for each case of performing battery pre-conditioning and not performing battery pre-conditioning. Furthermore, the determining unit may be configured to determine the expected charging time or the expected charging cost for each case of performing battery pre-conditioning and not performing battery pre-conditioning, based on the determined expected SOC.

For example, the determining unit may be configured to determine the expected SOC based on a current SOC, travel energy consumption due to travel to the found charging station, and conditioning consumption energy due to the battery pre-conditioning.

For example, the charging condition information may include an expected battery temperature upon a time of arrival at the found charging station. In addition, the determining unit may be configured to determine an expected battery temperature for each case of performing battery pre-conditioning and not performing battery pre-conditioning. Further, the determining unit may determine an expected charging time for each case of performing battery pre-conditioning and not performing battery pre-conditioning, based on the determined expected battery temperature.

For example, the determining unit may be configured to determine the expected battery temperature based on a current temperature of the battery, a temperature raised by travel to the found charging station, and a temperature raised by the battery pre-conditioning.

For example, the searching unit may be configured to check charging station information including output specifications of a charger at each found charging station. In addition, the determining unit may be configured to determine the charging condition information by additionally considering the charging station information.

For example, the interface unit may be configured to receive an input of a command for whether to perform the battery pre-conditioning after the outputting of the charging condition information.

Problems, according to the disclosure, may not be limited by the aforementioned problems, and other unmentioned problems can be clearly understood from the following description by those having ordinary skill in the art.

With the method and system for providing information for determining whether to enter the battery pre-conditioning, according to an embodiment of the disclosure, it is easy to compare various options by given information about each charging station satisfying a certain condition and the charging condition of each charging station based on whether to perform the battery pre-conditioning. Further, various expected charging times, expected charging costs, and the like are comprehensively taken into account to reasonably determine whether to enter the battery pre-conditioning.

Further, it is possible to rationally determine whether to enter the battery pre-conditioning, thereby preventing wasteful battery pre-conditioning and alleviating any decrease in charging efficiency due to additional control involved in the wasteful battery pre-conditioning.

Effects obtainable from the disclosure may not be limited by the aforementioned effects, and other unmentioned effects can be clearly understood from the following description by a person having ordinary skill in the art to which the present disclosure pertains.

### BRIEF DESCRIPTION OF THE DRAWINGS

FIG. 1 is a view showing an example of a configuration of an electrified vehicle applicable to embodiments of the disclosure.

FIG. 2 is a view showing an example of charging conditions without battery pre-conditioning, applicable to embodiments of the disclosure.

FIG. 3 is a view showing an example of charging conditions with battery pre-conditioning, applicable to embodiments of the disclosure.

FIG. 4 is a view showing a configuration of a system for providing information for determining whether to enter battery pre-conditioning, according to an embodiment of the disclosure.

FIG. 5 is a view showing information provided to determine whether to enter battery pre-conditioning, according to an embodiment of the disclosure.

FIG. 6 is a flowchart showing a method of providing information for determining whether to enter battery pre-conditioning, according to an embodiment of the disclosure.

### DETAILED DESCRIPTION

Regarding embodiments of the disclosure disclosed in this specification or application, the specific structural or functional description is merely illustrative for the purpose of describing the embodiments of the disclosure. Further, embodiments of the disclosure may be implemented in various forms and should not be construed as being limited to the embodiments set forth in this specification or application.

Because the embodiments of the disclosure may be variously modified and have various forms, specific embodiments are illustrated in the drawings and described in detail in this specification or application. However, it should be understood that embodiments of the disclosure are intended not to be limited to the specific embodiments but to cover all modifications, equivalents, or alternatives without departing from the spirit and technical scope of the disclosure.

Unless defined otherwise, all terms used herein including technical or scientific terms have the same meanings as those generally understood by a person having ordinary skill in the art to which the disclosure pertains. The terms such as those defined in generally used dictionaries are construed to have meanings matching that in the context of related technology and, unless clearly defined otherwise, are not construed to be ideally or excessively formal.

Hereinafter, embodiments of the disclosure are described in detail with reference to the accompanying drawings, in which the same or similar elements are denoted by the same reference numerals even though they are depicted in different drawings. Furthermore, redundant descriptions thereof have been avoided.

Suffixes “module” and “unit” put after elements in the following description are given in consideration of only the ease of constructing the description, and do not have meaning or functions discriminated from each other.

In terms of describing the embodiments of the disclosure, detailed descriptions of the related art have been omitted when they make the subject matter of the embodiments of the disclosure rather unclear. In addition, the accompanying drawings are provided only for a better understanding of the embodiments of the disclosure and are not intended to limit technical ideas of the disclosure. Therefore, it should be understood that the accompanying drawings include all modifications, equivalents, and substitutions within the scope and sprit of the disclosure.

Terms such as “first” and “second” may be used to describe various components, but the components should not be limited by the above terms. In addition, the above terms are used only for the purpose of distinguishing one component from another.

When it is described that one component is “connected” or “joined” to another component, it should be understood that the one component may be directly connected or joined to another component, but additional components may be present therebetween. However, when one component is described as being “directly connected,” or “directly coupled” to another component, it should be understood that additional components may be absent between the one component and another component. When a component, device, element, or the like of the present disclosure is described as having a purpose or performing an operation, function, or the like, the component, device, or element should be considered herein as being “configured to” meet that purpose or to perform that operation or function.

Unless the context clearly dictates otherwise, singular forms include plural forms as well.

In the disclosure, it should be understood that the terms “include” or “have” indicates that a feature, a number, a step, an operation, an element, a part, or the combination thereof described in the embodiments is present. However, the terms do not preclude a possibility of the presence or addition of one or more other features, numbers, steps, operations, elements, parts or combinations thereof, in advance.

Further, the terms “unit” or “control unit” forming part of the names of a hybrid control unit (HCU), and the like, are merely terms that are widely used in the naming of a controller for controlling a specific function of a vehicle, and should not be construed as meaning a generic function unit. For example, each control unit may include a communication device that communicates with other control units or sensors, in order to control its own functions, a memory that stores an operating system, logic commands, and input/output information, and one or more processors that perform determination, calculation, decision, and the like, which is necessary for the control of the function that is responsible therefor.

According to embodiments of the disclosure, in terms of performing control for battery pre-conditioning in an electrified vehicle of which a battery is chargeable with external power, factors taken into account in determining whether to enter the battery pre-conditioning are determined and provided according to cases with and without the battery pre-conditioning. Thus, the factors are helpful in determining whether to enter the battery pre-conditioning.

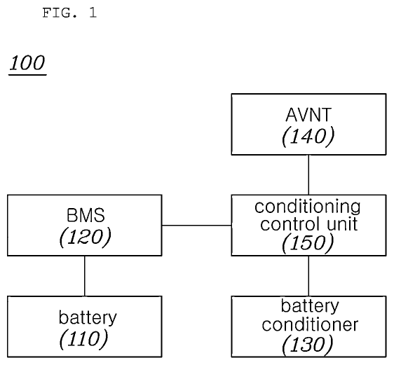

FIG. 1 is a view showing an example of a configuration of an electrified vehicle applicable to embodiments of the disclosure.

Referring to FIG. 1, an electrified vehicle 100, according to an embodiment, may include a battery 110, a battery management system (BMS) 120, a battery conditioner 130, audio/video/navigation/telematics (AVNT) 140, and a conditioning control unit 150. FIG. 1 focuses on elements related to the embodiments of the disclosure, and it should be understood by those having ordinary skill in the art that more or fewer elements may be included to actually implement a vehicle. The elements are further described below.

First, the battery 110 may supply power to an electric motor (not shown) that is a driving source of the electrified vehicle 100, or may be charged with power generated through regenerative braking or the like in the electric motor. Further, the battery 110 may be charged with external power supplied through a connection of a charging plug.

The BMS 120 may manage the states of the battery, e.g., the state of charge (SOC), temperature, current, voltage, the state of health, and the like.

The battery conditioner 130 may be called a battery warmer because it functions to raise the temperature of the battery 110. To this end, the battery conditioner 130 may include a heater, a pump for circulating a fluid heated by the heater around the battery 110, and the like. However, this is merely an example, and it should be understood by those having ordinary skill in the art that there may be various configurations for raising the temperature of the battery 110.

The AVNT 140 may perform a function of acquiring information about an external object (e.g., charging station information about a found charging station), or a function of acquiring information about a user's input in relation to embodiments of the disclosure, as well as basic functions of audio/video input and output and navigation. In this regard, details are described below.

The BMS 120 may acquire information about charging conditions that may affect a user's determination of whether to enter the battery pre-conditioning.

The conditioning control unit 150 may receive information from the BMS 120 or the AVNT 140, and determine whether to perform the battery pre-conditioning based on the received information. Further, the conditioning control unit 150 may issue a battery pre-conditioning command to the battery conditioner 130 so as to raise the temperature of the battery 110 according to the decision of whether to perform the battery pre-conditioning.

The conditioning control unit 150 may be implemented as a separate control unit, may be implemented as a certain function of a control unit generally mounted to the electrified vehicle 100, or may be implemented as distributed to two or more control units. In general, the mounted control unit may, for example, include, but is not limited to, a vehicle control unit (VCU) in the case of an electric vehicle, and a hybrid control unit (HCU) in the case of a plug-in hybrid electric vehicle (PHEV).

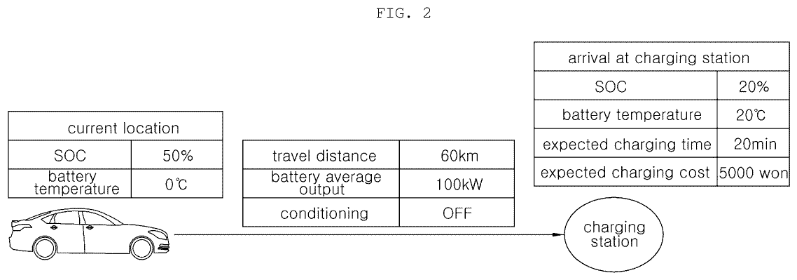

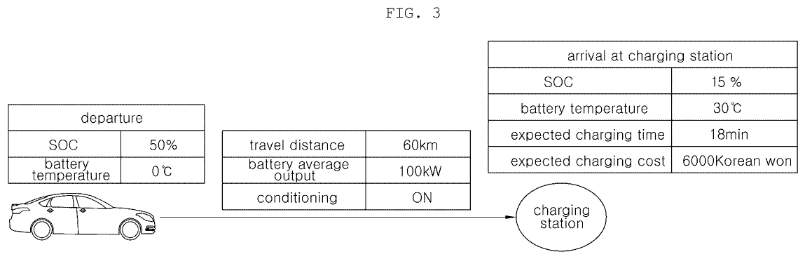

FIG. 1 shows the configuration of the electrified vehicle to which the method and system for providing information for determining whether to enter the battery pre-conditioning are applicable, according to the embodiments of the disclosure. Charging conditions that affect the determination of whether to enter the battery pre-conditioning are described below with reference to FIGS. 2 and 3.

FIG. 2 is a view showing an example of charging conditions without the battery pre-conditioning that are applicable to the embodiments of the disclosure.

Referring to FIG. 2, the electrified vehicle 100 has an SOC of 50% and a battery temperature of 0° C. before the electrified vehicle 100 starts traveling to a charging station. As shown in FIG. 2, the electrified vehicle 100 travels to the charging station without the battery pre-conditioning.

The electrified vehicle 100 travels while consuming energy stored in the battery, and therefore the SOC of the battery is affected by a travel distance and a battery's average output. As shown in FIG. 2, the SOC of the electrified vehicle 100, which was 50% before the traveling, is decreased by 30% while traveling km to the charging station with an average output of 100 kW, and becomes 20% on arrival at the charging station.

Further, the temperature of the battery in the electrified vehicle 100 is affected by the battery's average output, an outside temperature, a travel distance, a travel time, and the like. Therefore, the temperature of the battery may be raised as the traveling causes the battery to generate heat even when the battery pre-conditioning is not performed. As shown in FIG. 2, the temperature of the battery, which was 0° C. before the traveling, is increased by 20° C. while traveling 60 km to the charging station with the average output of 100 kW, and becomes 20° C. on arrival at the charging station.

Charging time is affected by the SOC of the battery. With respect to one target SOC, the lower the SOC is than the target SOC, the more power is required to be supplied to reach the target SOC, and thus it takes more time to charge the battery up to the target SOC.

Further, the charging time is also affected by the temperature of the battery. The charging time is sensitive to temperature conditions. When the temperature of the battery is excessively high or low, a charging efficiency is lowered, and the charging takes longer. In general, the issue of whether to perform the battery pre-conditioning is relevant to a case where the charging time increases due to the low temperature of the battery. Accordingly, embodiments of the disclosure are described based on an example of where the battery has a low temperature.

The charging cost is generally affected by the SOC of the battery. With respect to one target SOC, the lower the SOC is than the target SOC, the more power is required to be supplied so as to reach the target SOC. Thus, the charging cost also increases.

While the charging conditions without the battery pre-conditioning are illustrated in FIG. 2, charging conditions with the battery pre-conditioning are described below with reference to FIG. 3.

FIG. 3 is a view showing an example of charging conditions with the battery pre-conditioning, applicable to the embodiments of the disclosure. The charging conditions of FIG. 3 are similar to those of FIG. 2 except that the electrified vehicle 100 travels to the charging station while performing the battery pre-conditioning. Thus, the descriptions are made focusing on the differences from those of FIG. 2.

When the battery pre-conditioning is performed, the temperature of the battery is raised to an optimum temperature or target temperature for charging, and the raised temperature is maintained until the vehicle arrives at the charging station or until the charging starts or is commenced. Therefore, the temperature of the battery is varied depending on whether or not the battery pre-conditioning is performed, and the temperature of the battery with the battery pre-conditioning is higher than that of the temperature of the battery without the battery pre-conditioning.

Because energy is consumed in addition to the energy consumed during traveling when the battery pre-conditioning is performed, the SOC upon a time of arrival at the charging station is lower than that of when the battery pre-conditioning is not performed. In the example of FIG. 3, which is different from FIG. 2 only in that the battery pre-conditioning is performed under the same conditions of the travel distance and the output, the SOC upon the time of arrival at the charging station is lower than that of FIG. 2.

The charging time of the battery is affected by the temperature of the battery. In particular, in a low temperature range, the higher the temperature of the battery, the shorter the charging time. Therefore, when the temperature of the battery is raised by performing the battery pre-conditioning, the charging time is shortened. The charging time of the battery is affected by the SOC of the battery. As the energy is consumed by performing the battery pre-conditioning, the SOC upon a time of arrival is lower than that upon a time of departure, and thus the charging time increases. Accordingly, it is necessary to determine an expected charging time by taking both the battery temperature change and the energy consumption due to the battery pre-conditioning into account, and then determine whether to enter the battery pre-conditioning.

Further, the battery charging cost is generally affected by the SOC, and the battery charging cost is therefore necessary to determine whether to enter the battery pre-conditioning by additionally considering the energy consumed by performing the battery pre-conditioning.

As discussed above, whether to enter the battery pre-conditioning may be determined based on the charging time and charging cost expected in consideration of the SOC and temperature of the battery upon the time of arrival at the charging station. Thus, a user may determine whether to enter the battery pre-conditioning so as to be more advantageous for charging or meeting a condition based on the comparison between the charging conditions with the battery pre-conditioning and the charging conditions without the battery pre-conditioning. Further, such information about the charging conditions is transmitted to the conditioning control unit 150 or the like of the electrified vehicle 100. The conditioning control unit 150 is previously set based on the charging condition and whether to perform the battery pre-conditioning, thereby controlling the battery pre-conditioning based on the information about the charging conditions.

FIGS. 2 and 3 show the charging conditions with and without the battery pre-conditioning, applicable to the embodiments of the disclosure. Prior to describing a method of providing information for determining whether to enter the battery pre-conditioning, embodiments of a system for providing information for determining whether to enter the battery pre-conditioning are described below based on the foregoing structure of the vehicle and the examples of the charging conditions with or without the battery pre-conditioning.

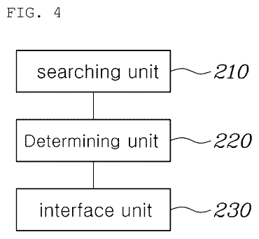

FIG. 4 is a view showing a configuration of a system for providing information for determining whether to enter battery pre-conditioning according to an embodiment of the disclosure.

Referring to FIG. 4, the system for providing information for determining whether to enter the battery pre-conditioning, according to an embodiment of the disclosure, includes a searching unit 210, a determining unit 220, and an interface unit 230. Such elements are further described in detail below.

First, the searching unit 210 searches for at least one charging station that satisfies a certain condition based on the current location of the vehicle. The certain condition may include a distance between the vehicle and the charging station, and an expected arrival time. Further, the searching unit 210 may check information about the charging station, such as output specifications of a charger at the found charging station, and may determine whether the condition is satisfied or not based on the checked information about the charging station. The searching unit 210 may be implemented separately from the vehicle, or may be implemented as the AUNT 140.

The determining unit 220 determines charging condition information about at least one charging station found by the searching unit 210 according to whether the battery pre-conditioning is performed or not. The charging condition information includes at least one of the expected charging costs or the expected charging time. The charging condition information may further include the expected SOC or expected battery temperature upon the time of arrival at the charging station.

To this end, the determining unit 220 may determine the expected SOC upon the time of arrival at the found charging station. In this case, the determining unit 220 may determine the expected SOC based on the current SOC (%), the travel energy consumption (kWh) corresponding to travel to the found charging station, and the conditioning energy consumption (kWh) corresponding to the battery pre-conditioning. The SOC is generally expressed in units of %, and thus the foregoing determination of the expected SOC may mean that the energy consumption (kWh) is first applied to the capacity of the battery and converted in units of % and then subtracted from the current SOC. Alternatively, the current SOC may be converted into units of kWh for the energy, and a value may be obtained by subtracting the energy consumption from the converted energy corresponding to the current SOC and converted again into units of %.

For example, when the battery pre-conditioning is not performed, a value obtained by subtracting a travel energy consumption value based on the travel distance and the battery average output from a converted energy value corresponding to the current SOC is converted into units of %, thereby determining the expected SOC upon the time of arrival at the charging station.

On the other hand, when the battery pre-conditioning is performed, the energy consumption based on the conditioning needs is additionally taken into account, and therefore a value obtained by further subtracting a conditioning energy consumption value based on conditioning time and conditioning power consumption (kW) is converted into units of %. Thus, the expected SOC upon the time of arrival at the charging station is determined.

As discussed above, when the expected SOC upon the time of arrival at the charging station is determined, the determining unit 220 may determine the expected charging cost or the expected charging time based on the expected SOC. In this case, the lower the expected SOC, the higher the expected charging cost and the longer the expected charging time. On the other hand, the higher the expected SOC, the lower the expected charging cost and the shorter the charging time.

Further, the determining unit 220 may determine the expected battery temperature upon the time of arrival at the found charging station. In this case, the determining unit 220 may determine the expected battery temperature based on the current temperature of the battery, the temperature raised due to the travel to the charging station, and the temperature raised due to the battery pre-conditioning. The raised temperature is not the temperature to which heating is carried out but a difference between the temperature before and after the heating.

For example, when the battery pre-conditioning is not performed, the temperature raised due to the travel to the found charging station is added to the current temperature of the battery, thereby determining the expected battery temperature. The temperature raised due to the travel may be based on a battery average output, an outside temperature, a travel time, and the like.

On the other hand, when the battery pre-conditioning is performed, the temperature raised due to the conditioning needs to be taken into account.

The temperature of the battery may be raised due to heat generated by the travel even when the battery pre-conditioning is performed. However, when the temperature of the battery reaches a target temperature, the battery pre-conditioning is controlled to maintain the target temperature. Therefore, when a remaining travel time to the charging station is long enough to achieve the target battery temperature through the battery pre-conditioning before arriving at the charging station, the target battery temperature may be determined as the expected battery temperature upon the time of arrival at the charging station without considering the temperature raised due to the travel.

On the other hand, when the remaining travel time is too short to achieve the target temperature, the expected battery temperature may be different from the target battery temperature. Therefore, a temperature obtained by adding the temperature raised by the travel and the temperature raised by the battery pre-conditioning to the current temperature of the battery may be determined as the expected battery temperature upon the time of arrival at the charging station. The temperature raised by the battery pre-conditioning may be based on conditioning operating time and conditioning power consumption.

As discussed above, when the expected battery temperature on the time of arrival at the charging station is determined, the determining unit 220 may determine the expected charging time based on the expected battery temperature. In this case, the lower the expected battery temperature, the longer the expected charging time. On the other hand, the higher the expected battery temperature, the shorter the charging time.

Further, the determining unit 220 may obtain information about the charging station found by the searching unit 210, such as output specifications of a charger at the charging station, and determine charging condition information based on the charging station information. The charging time and the charging cost may be varied depending on the output specifications of the charger, and the output specifications of the charger may be different according to the charging station. For example, fast or ultrafast charging has a shorter charging time and higher charging cost than normal slow charging. Therefore, the output specifications of the charger may be reflected more reasonably in determining which charging station to use and whether to enter the battery pre-conditioning.

The determining unit 220 may consider all of the foregoing expected SOC, expected battery temperature, and the charging station information, including the output specifications of the charger, to determine the charging condition information. The more factors there are to be taken into account, the more helpful the charging condition information is in selecting the charging station and determining whether to enter the battery pre-conditioning.

The determining unit 220 may be implemented as a separate element, but may also be implemented as the BMS 120.

The interface unit 230 outputs the charging condition information determined by the determining unit. The output information may be given to a user, the conditioning control unit 150, and the like. When given the output information, a user, the conditioning control unit 150, and the like may determine whether to enter the battery pre-conditioning based on the output information. In this case, the interface unit 230 may be implemented as the AVNT 140 of the vehicle, a user terminal, and the like. Further, the charging condition information may be visually displayed through the display of the AVNT 140, the user terminal, and the like.

Further, the interface unit 240 may receive an input of a command for whether to perform the battery pre-conditioning after the output of the charging condition information. Thus, a user or the like that receives the charging condition information corresponding to whether or not the battery pre-conditioning is performed according to the charging stations can determine whether to enter the battery pre-conditioning based on the received charging condition information. The input command for whether to perform the battery pre-conditioning is transmitted to the conditioning control unit 150 and the like, so that the conditioning control unit 150 can control the battery conditioner 130 based on the input command.

Thus, it is easy to compare various options by the information given about each charging station satisfying a certain condition and the charging condition of each charging station based on whether to perform the battery pre-conditioning. Further, various expected charging times, expected charging costs, and the like are comprehensively taken into account to reasonably determine whether to enter the battery pre-conditioning.

In addition, it is possible to rationally determine whether to enter the battery pre-conditioning, thereby preventing wasteful battery pre-conditioning and alleviating any decrease in charging efficiency due to additional control involved in the wasteful battery pre-conditioning.

Besides, when a plurality of charging stations are found, it is possible to select not only whether to perform the battery pre-conditioning until arriving at the charging station but also which charging station to use, thereby providing various options.

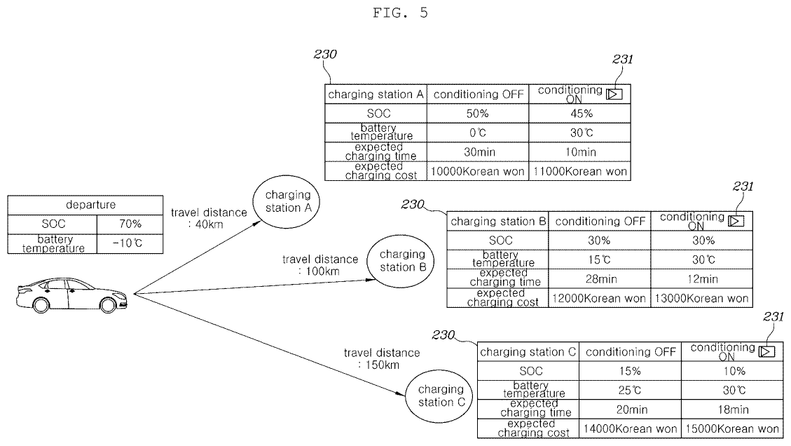

FIG. 4 shows a configuration of the system for providing information for determining whether to enter the battery pre-conditioning according to an embodiment of the disclosure. The provided information is described below with reference to FIG. 5.

FIG. 5 is a view showing information provided to determine whether to enter battery pre-conditioning, according to an embodiment of the disclosure.

Referring to FIG. 5, the system for providing information for determining whether to enter the battery pre-conditioning, according to an embodiment of the disclosure, provides information about found charging stations A, B, and C, and charging conditions with ON/OFF battery pre-conditioning at each charging station. Such information about the charging condition may be visually provided through the display or the like, as shown in FIG. 5. The determination of whether to enter the battery pre-conditioning according to a user's preference or the like conditions based on the provided charging condition information is described below.

First, as illustrated in FIG. 5, when the SOC is high enough that there is no need for immediate charging, the charging station C corresponding to a long travel distance may be selected. In this case, the travel distance is long enough to raise the temperature of the battery without performing the battery pre-conditioning. Thus, a difference between the expected charging time with the battery pre-conditioning and the expected charging time without the battery pre-conditioning is merely 2 minutes. Therefore, a user may make a selection not to perform the battery pre-conditioning, thereby reducing the charging cost. When energy consumption due to travel after charging at the charging stations A and B is taken into account, the charging at the charging station C, which corresponds to the longest travel distance without performing the battery pre-conditioning, makes it possible to reduce the charging cost and shorten the charging time.

On the other hand, when charging is required as soon as possible due to a low SOC of a vehicle, and a user wants to charge the vehicle at a nearby charging station, the charging station A, corresponding to the shortest travel distance, may be selected as a destination. In this case, an expected charging time is 10 minutes, and an expected charging cost is 11000 Korean won when the battery pre-conditioning is performed. However, when the battery pre-conditioning is not performed, an expected charging time is 30 minutes and an expected charging cost is 10000 Korean won. Furthermore, when a user considers the charging time, the battery pre-conditioning is performed to shorten the charging time by 20 minutes. On the other hand, when a user prioritizes the charging cost, the battery pre-conditioning is not performed to reduce the charging cost by 1000 Korean won even though the charging time increases.

The information providing system, according to an embodiment of the disclosure, may provide the charging condition information for each found charging station for each case of performing battery pre-conditioning and not performing battery pre-conditioning. Furthermore, the information providing system may receive an input of a command for whether to perform the battery pre-conditioning. The input of the command for whether to perform the battery pre-conditioning may be performed through the interface unit 230, and may, as shown in FIG. 5, be received as a user clicks a run button 231 displayed together with the charging condition information.

Thus, it is easy to compare various options by the information given about each charging station satisfying a certain condition and the charging condition of each charging station based on whether to perform the battery pre-conditioning. Further, various expected charging times, expected charging costs, and the like are comprehensively taken into account to reasonably determine whether to enter the battery pre-conditioning.

Furthermore, when a plurality of charging stations are found, it is possible to select not only whether to perform the battery pre-conditioning until arriving at the charging station but also which charging station to use, thereby providing various options.

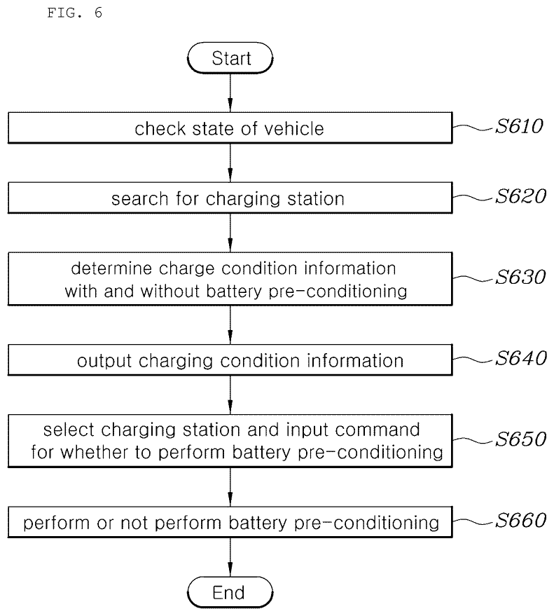

The foregoing descriptions are illustrated as a flowchart in FIG. 6.

FIG. 6 is a flowchart showing a method of providing information for determining whether to enter battery pre-conditioning. According to an embodiment of the disclosure, the method of providing information for determining whether to enter the battery pre-conditioning includes: searching for at least one charging station that satisfies a certain condition based on the current location of the vehicle (S620); determining charging condition information about at least one found charging station for each case of performing battery pre-conditioning and not performing battery pre-conditioning (S630); and outputting the determined charging condition information (S640). The information providing method, according to an embodiment of the disclosure, is described below in detail.

Referring to FIG. 6, the information providing method, according to an embodiment of the disclosure, may further include a step of checking the current temperature and SOC of the battery in the vehicle (S610). Step S610 may be carried out as the BMS 120 of the electrified vehicle 100 transmits information about the temperature, SOC, and the like, of the battery to the determining unit 220.

The searching unit 210 searches for at least one charging station that satisfies a certain condition based on the current location of the vehicle (S620). Determining whether the charging station satisfies the conditions may be based on a distance between the vehicle and the charging station, an expected arrival time, and the like. Further, determining whether the charging station satisfies the conditions may be done in consideration of whether the charger of the corresponding charging station supports fast charging or ultrafast charging

After the charging station is found, the determining unit 220 determines the charging condition information about at least one found charging station with and without the battery pre-conditioning (S630). The charging condition information includes at least one of the expected charging cost or the expected charging time, and may further include the expected SOC or the expected battery temperature upon the time of arrival at the charging station. In step S630, the determining unit 220 may determine the expected SOC upon the time of arrival at the found charging station based on the checked current SOC of the vehicle, travel energy consumption due to travel to the found charging station, and conditioning energy consumption due to the battery pre-conditioning. The SOC is generally expressed in units of %, and thus the foregoing determination of the expected SOC may mean that the energy consumption (kWh) is first applied to the capacity of the battery and converted into units of % and then subtracted from the current SOC. Alternatively, the current SOC may be converted into units of kWh for the energy, and a value may be obtained by subtracting the energy consumption from the converted energy corresponding to the current SOC and converted again into units of %.

For example, when the battery pre-conditioning is not performed, a value obtained by subtracting a travel energy consumption value that is based on the travel distance and the battery average output from a converted energy value corresponding to the current SOC, is converted into units of %, thereby determining the expected SOC upon the time of arrival at the charging station.

On the other hand, when the battery pre-conditioning is performed, the energy consumption based on the conditioning needs to be additionally taken into account. Therefore a value obtained by further subtracting a conditioning energy consumption value based on conditioning time and conditioning power consumption (kW) is converted into units of %, thereby determining the expected SOC upon the time of arrival at the charging station.

Further, the determining unit 220 may determine the expected battery temperature upon the time of arrival at the found charging station, and consider the expected battery temperature, thereby determining the expected charging time. In this case, the expected battery temperature may be determined based on the current temperature of the battery, the temperature raised by travel to the found charging station, and the temperature raised by the battery pre-conditioning.

For example, when the battery pre-conditioning is not performed, the temperature raised due to the travel to the found charging station is added to the current temperature of the battery, thereby determining the expected battery temperature. The temperature raised due to the travel may be based on a battery average output, an outside temperature, a travel time, and the like.

On the other hand, when the battery pre-conditioning is performed, the temperature raised due to the conditioning needs to be taken into account.

The temperature of the battery may be raised due to heat generated by the travel even when the battery pre-conditioning is performed. However, when the temperature of the battery reaches a target temperature, the battery pre-conditioning is controlled to maintain the target temperature. Therefore, when a remaining travel time to the charging station is long enough to achieve the target battery temperature through the battery pre-conditioning before arriving at the charging station, the target battery temperature may be determined as the expected battery temperature upon the time of arrival at the charging station without considering the temperature raised due to the travel.

On the other hand, when the remaining travel time is too short to achieve the target temperature, the expected battery temperature may be different from the target battery temperature. Therefore, a temperature obtained by adding the temperature raised by the travel and the temperature raised by the battery pre-conditioning to the current temperature of the battery may be determined as the expected battery temperature upon the time of arrival at the charging station. The temperature raised by the battery pre-conditioning may be based on conditioning operating time and conditioning power consumption. Further, the determining unit 220 may obtain information about the charging station found by the searching unit 210, such as output specifications of a charger at the charging station, and determine charging condition information based on the charging station information. The charging time and the charging cost may be varied depending on the output specifications of the charger. Furthermore, the output specifications of the chargers may be different according to the charging stations. For example, fast or ultrafast charging has a shorter charging time and a higher charging cost than normal slow charging. Therefore, the output specifications of the charger may be reflected more reasonably in determining which charging station to use and whether to enter the battery pre-conditioning. When the charging condition information is determined as described above by the determining unit 220, the interface unit 230 outputs the determined information (S640). The output information may be transmitted to a user, the conditioning control unit 150, and the like so as to determine whether to enter the battery pre-conditioning based on the output information. When it is determined whether to enter the battery pre-conditioning, based on the output information, step S650 is carried out to select the charging station and receive an input about whether to perform the battery conditioning. Step S650 may be carried out as the interface unit 230 receives an input of a command for whether to perform the battery pre-conditioning. Alternatively, step S650 may be carried out as the conditioning control unit 150 or the like generates a signal or the like for entering the battery pre-conditioning.

When the command for whether to perform the battery pre-conditioning is inputted, the conditioning control unit 150 may control the battery conditioner 130. Therefore, it is determined whether to perform the battery pre-conditioning (S660).

Thus, it is easy to compare various options by the information given about each charging station satisfying a certain condition and the charging condition of each charging station based on whether or not the battery pre-conditioning is performed. Further, various expected charging times, expected charging costs, and the like are comprehensively taken into account to reasonably determine whether to enter the battery pre-conditioning.

Further, it is possible to rationally determine whether to enter the battery pre-conditioning, thereby preventing wasteful battery pre-conditioning and alleviating any decrease in charging efficiency due to additional control involved in the wasteful battery pre-conditioning.

In addition, when a plurality of charging stations is found, it is possible to select not only whether to perform the battery pre-conditioning until arriving at the charging station, but also which charging station to use, thereby providing various options.

Although specific embodiments of the disclosure have been illustrated and described herein, various modifications and changes can be made by a person having ordinary skill in the art without departing from the scope of technical ideas defined by the appended claims.

What is claimed is:

1. A method of providing information for determining whether to enter battery pre-conditioning, the method comprising:
searching for at least one charging station that satisfies a certain condition based on a current location of a vehicle;
determining charging condition information about at least one found charging station for each case of performing battery pre-conditioning and not performing battery pre-conditioning; and
outputting the determined charging condition information.

2. The method of claim 1, wherein the charging condition information comprises at least one of an expected charging cost or an expected charging time.

3. The method of claim 2, wherein
the charging condition information further comprises an expected state of charge (SOC) upon a time of arrival at the found charging station, and
the determining the charging condition information comprises:
determining the expected SOC for each case of performing battery pre-conditioning and not performing battery pre-conditioning; and
determining the expected charging time or the expected charging cost for each case of performing battery pre-conditioning and not performing battery pre-conditioning, based on the determined expected SOC.

4. The method of claim 3, wherein the determining the expected SOC comprises determining the expected SOC based on a current SOC, travel energy consumption due to travel to the found charging station, and conditioning consumption energy due to the battery pre-conditioning.

5. The method of claim 2, wherein
the charging condition information comprises an expected battery temperature upon a time of arrival at the found charging station, and
the determining the charging condition information comprises:
determining an expected battery temperature for each case of performing battery pre-conditioning and not performing battery pre-conditioning; and
determining an expected charging time for each case of performing battery pre-conditioning and not performing battery pre-conditioning, based on the determined expected battery temperature.

6. The method of claim 5, wherein
the determining the expected battery temperature comprises determining the expected battery temperature based on a current temperature of the battery, a temperature raised by travel to the found charging station, and a temperature raised by the battery pre-conditioning.

7. The method of claim 1, further comprising checking charging station information comprising output specifications of a charger at each found charging station,
wherein the determining the charging condition information comprises determining the charging condition information by additionally considering the charging station information.

8. The method of claim 1, further comprising receiving an input of a command for whether to perform the battery pre-conditioning after the outputting.

9. A system for providing information for determining whether to enter battery pre-conditioning, the system comprising:
a searching unit configured to search for at least one charging station that satisfies a certain condition based on a current location of a vehicle;
a determining unit configured to determine charging condition information about at least one found charging station for each case of performing battery pre-conditioning and not performing battery pre-conditioning; and
an interface unit configured to output the determined charging condition information.

10. The system of claim 9, wherein the charging condition information comprises at least one of an expected charging cost or an expected charging time.

11. The system of claim 10, wherein
the charging condition information further comprises an expected state of charge (SOC) upon a time of arrival at the found charging station, and
the determining unit is configured to determine the expected SOC for each case of performing battery pre-conditioning and not performing battery pre-conditioning, and determine the expected charging time or the expected charging cost for each case of performing battery pre-conditioning and not performing battery pre-conditioning, based on the determined expected SOC.

12. The system of claim 11, wherein the determining unit is configured to determine the expected SOC based on a current SOC, travel energy consumption due to travel to the found charging station, and conditioning consumption energy due to the battery pre-conditioning.

13. The system of claim 10, wherein
the charging condition information comprises an expected battery temperature upon a time of arrival at the found charging station, and
the determining unit is configured to determine an expected battery temperature for each case of performing battery pre-conditioning and not performing battery pre-conditioning, and determine an expected charging time for each case of performing battery pre-conditioning and not performing battery pre-conditioning, based on the determined expected battery temperature.

14. The system of claim 13, wherein the determining unit is configured to determine the expected battery temperature based on a current temperature of the battery, a temperature raised by travel to the found charging station, and a temperature raised by the battery pre-conditioning.

15. The system of claim 9, wherein
the searching unit is configured to check charging station information comprising output specifications of a charger at each found charging station, and
the determining unit is configured to determine the charging condition information by additionally considering the charging station information.

16. The system of claim 9, wherein the interface unit is configured to receive an input of a command for whether to perform the battery pre-conditioning after the outputting of the charging condition information.
